(19) United States
(12) Patent Application Publication
(10) Pub. No.: US 2013/0006858 A1
(43) Pub. Date: Jan. 3, 2013

(54) SYSTEM AND METHOD FOR AUTOMATICALLY UPDATING A PURCHASE CARD ACCOUNT BASED ON TRAVEL OF THE CARD USER

(75) Inventor: Matthew DePetro, Sunnyvale, CA (US)

(73) Assignee: FUJITSU LIMITED, Kanagawa (JP)

(21) Appl. No.: 13/175,395

(22) Filed: Jul. 1, 2011

(51) Int. Cl. G06Q 40/00

(52) U.S. Cl. 705/44

(57) ABSTRACT

According to some embodiments of the present disclosure, a method for modifying a purchase card account according to travel by a user of a purchase card comprises receiving, at a card issuer information handling system associated with a card issuer of a purchase card, a computer readable travel notification file. The travel notification file indicates a destination of travel of a card user of the purchase card, a time period of travel to the destination, account information associated with the purchase card and confirmation information indicating whether travel to the destination likely occurred. The method further comprises modifying, by the card issuer information handling system, an account associated with the purchase card based on the travel notification file to authorize use of the purchase card at the destination of travel during the time period of travel.

### TECHNICAL FIELD

The present disclosure relates in general to communications, and more particularly, to systems and methods for automatically updating a purchase card account based on travel of the purchase card user.

### BACKGROUND

Purchase cards (e.g., credit and debit cards) are ubiquitous in the commercial transactions of consumers and businesses alike. Credit and debit card fraud is also highly prevalent. As a fraud prevention measure, many credit and debit card issuers place geographic limits on where a card may be used. These limits generally relate to a particular area surrounding the home of the consumer or location of the business. Accordingly, when traveling to areas that may be outside of these geographic limits, a card user may need to notify the card issuer such that anti-fraud measures (e.g., holds on the account) that may prevent the user from using the card while traveling in areas outside of the geographic limits may be disabled.

The notification process may entail the user contacting a customer service representative to notify the card issuer of the card user's travel plans. This process can be cumbersome and time consuming. Additionally, if a card user forgets to notify the card issuer, the user may not be able to use the card in the area of travel, much to the user's inconvenience. Further, in such instances the process of removing the geographic fraud prevention measures after the fact may require even more time and inconvenience.

### SUMMARY

According to some embodiments of the present disclosure, a method for modifying a purchase card account according to travel by a user of a purchase card comprises receiving, at a card issuer information handling system associated with a card issuer of a purchase card, a computer readable travel notification file. The travel notification file indicates a destination of travel of a card user of the purchase card, a time period of travel to the destination, account information associated with the purchase card and confirmation information indicating whether travel to the destination likely occurred. The method further comprises modifying, by the card issuer information handling system, an account associated with the purchase card based on the travel notification file to authorize use of the purchase card at the destination of travel during the time period of travel.

### BRIEF DESCRIPTION OF THE DRAWINGS

For a more complete understanding of the present disclosure and its advantages, reference is now made to the following description, taken in conjunction with the accompanying drawings, in which:

FIG. 1 illustrates an example embodiment of a system configured to notify a card issuer of a card user's travel, in accordance with some embodiments of the present disclosure;

FIG. 2 illustrates an example of card information used to notify a card issuer of a card user's travel, in accordance with some embodiments of the present disclosure;

FIG. 3 illustrates an example of travel information used to notify a card issuer of a card user's travel, in accordance with some embodiments of the present disclosure;

FIG. 4 illustrates an example of a notification file used to notify a card issuer of a card user's travel, in accordance with some embodiments of the present disclosure;

FIG. 5 illustrates an example method for notifying a card issuer of travel of a card user, in accordance with some embodiments of the present disclosure;

FIG. 6 illustrates an example embodiment of a system configured to notify a card issuer of a card user's travel based on travel booking information, in accordance with some embodiments of the present disclosure;

FIG. 7 illustrates an example of booking information that may used to notify a card issuer of a card user's travel, according to some embodiments of the present disclosure;

FIGS. 8A and 8B illustrate example calendar files that may used to notify a card issuer of a card user's travel, according to some embodiments of the present disclosure; and

FIG. 9 illustrates an example method for generating a notification file based on travel booking information.

### DETAILED DESCRIPTION

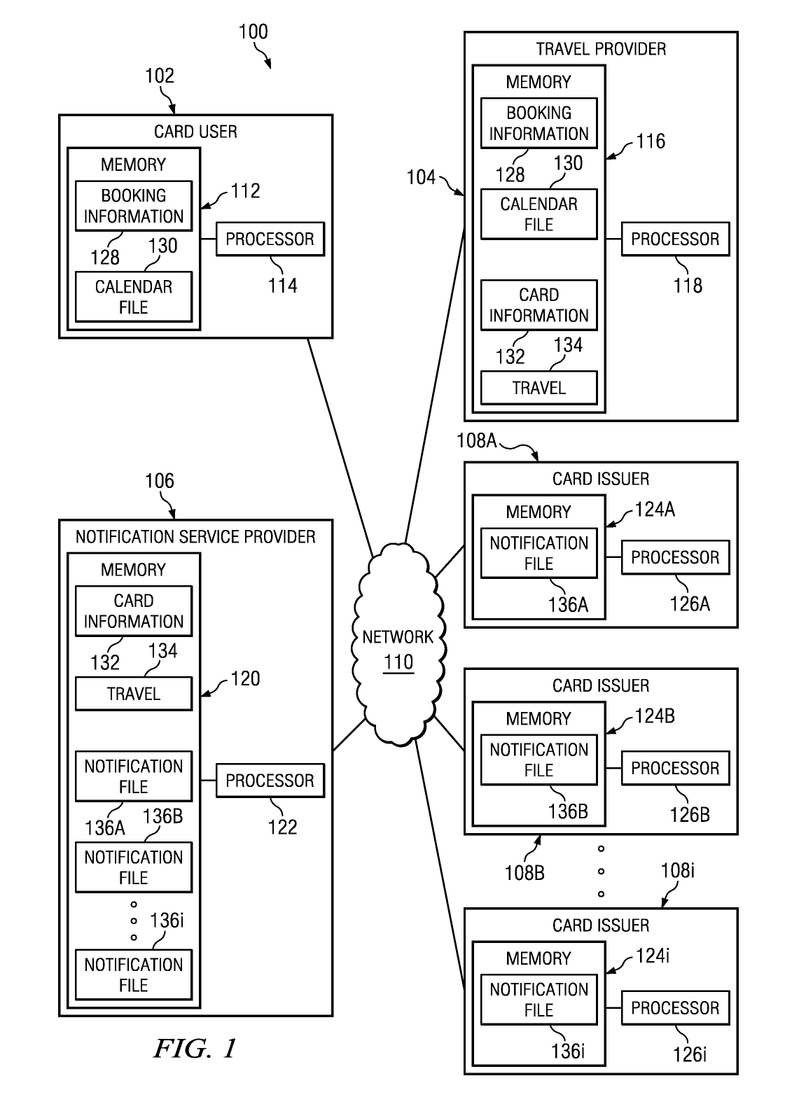

FIG. 1 illustrates an example embodiment of a system 100 configured to notify a purchase card (e.g., debit card and/or credit card) issuer of a card user's travel plans, in accordance with some embodiments of the present disclosure. As discussed in further detail below, a card user may provide desired travel information to a travel provider. The travel provider may book the card user's travel using the desired travel information and may transmit the information to a notification service provider. Based on the booked travel, the notification service provider may then notify the card issuer of the card user's travel plans such that the card issuer may allow use of the card in the area of travel during the indicated time period. Therefore, the card issuer may be conveniently notified of the card user's travel such that the card user may be able to use the card while traveling.

In the present disclosure, a card user may comprise any person (or representative of the person) who may use a purchase card or who may have a purchase card account. A travel provider may refer to any entity that provides travel and travel related services. For example, a travel provider may be a travel agency, an online travel tool (e.g., Expedia, Orbitz, Priceline, etc.), an airline, a bus line, a cruise line, a railroad, a car rental provider, a lodging provider (e.g., a hotel) etc. A card issuer may comprise any entity that may issue a purchase card such as a bank, a credit union, a credit card company, or other financial institution.

A notification service provider may comprise any entity that may serve as an intermediary between card issuers, card users and/or travel providers. The notification service provider may have a relationship of trust with each of these entities such that each entity may trust communications to and from the notification service provider. Accordingly, the notification service provider may reduce transaction costs associated with having to establish a relationship of trust between many parties. For example, instead of having to establish a relationship of trust with each travel provider, a card issuer may have a trusting relationship with a notification service provider, which may receive travel information from travel providers trusted by the notification service provider. The notification service provider may accordingly communicate to the card issuer the travel information received from the trusted travel providers. Accordingly, the notification service provider may act as a central point for trusted communication.

System 100 may include a card user information handling system (IHS) 102, a travel provider IHS 104, a notification service provider IHS 106 and card issuer IHS's 108 configured to perform operations associated with a card user, a travel provider, a notification service provider and a card issuer respectively, as described further below. An information handling system (IHS) may comprise any instrumentality or aggregate of instrumentalities configured to compute, classify, process, transmit, receive, retrieve, originate, switch, store, display, manifest, detect, record, reproduce, handle, or utilize any form of information, intelligence, or data for business, scientific, control, entertainment, or other purposes. For example, an IHS may be a personal computer, a PDA, a smart phone, a consumer electronic device, a network storage device, a server or any other suitable device and may vary in size, shape, performance, functionality, and price.

Card user IHS 102 may include a memory 112 and a processor 114 communicatively coupled to each other; travel provider IHS 104 may include a memory 116 and a processor 118 communicatively coupled to each other; notification service provider IHS 106 may include a memory 120 and a processor 122 communicatively coupled to each other; and each card issuer IHS 108 may include a memory 124 and a processor 126 communicatively coupled to each other.

A processor may comprise any suitable system, apparatus or device configured to interpret and/or execute program instructions and/or process data, and may include without limitation a microprocessor, microcontroller, digital signal processor (DSP), application specific integrated circuit (ASIC), or any other digital or analog circuitry configured to interpret and/or execute program instructions and/or process data. In the present embodiments, processors 114, 118, 122 and 126 may interpret and/or execute program instructions and/or process data stored in memories 112, 116, 120 and 124, respectively. Processors 114, 118, 122 and 126 may also be configured to direct storage of data in memories 112, 116, 120 and 124 respectively.

Memory may comprise any system, device or apparatus configured to retain program instructions or data for a period of time (e.g., computer-readable media). Memory may include random access memory (RAM), electrically erasable programmable read-only memory (EEPROM), a PCMCIA card, flash memory, magnetic storage, opto-magnetic storage, or any suitable selection and/or array of volatile or non-volatile memory that retains data after power to its respective processor is turned off.

Card user IHS 102, travel provider IHS 104, notification service provider IHS 106 and each card issuer IHS 108 may be communicatively coupled to one or more of the other IHS's via a network 110. In certain embodiments, network 110 may be a communication network. A communication network may allow an IHS to communicate with one or more other IHS's. A communication network may comprise all or a portion of one or more of the following: a public switched telephone network (PSTN), a public or private data network, a local area network (LAN), a metropolitan area network (MAN), a wide area network (WAN), a local, regional, or global communication or computer network such as the Internet, a wireline or wireless network, an optical network, an enterprise intranet, other suitable communication link, or any combination thereof.

In the present embodiment, a card user (or representative thereof) may utilize card user IHS 102 to provide desired travel information to a travel provider IHS 104 via network 110. For example a card user may use a personal computer to access a travel provider website using card user IHS 102 and network 110 (e.g., the Internet). During this access, the card user may choose a desired mode of transportation (e.g., boat, airplane, train, bus) of arriving at a desired location at another desired time and may choose a means of returning from the desired location at a desired time. In the same or alternative embodiments, a card user may indicate desired lodging and/or a desired car rental in a certain city for a certain period of time using a travel provider website. In other embodiments, rather than using card user IHS 102, a card user (or representative thereof) may communicate with an agent of the travel provider (e.g., via telephone) regarding the card user's desired travel. The agent may enter the desired travel in travel provider IHS 104.

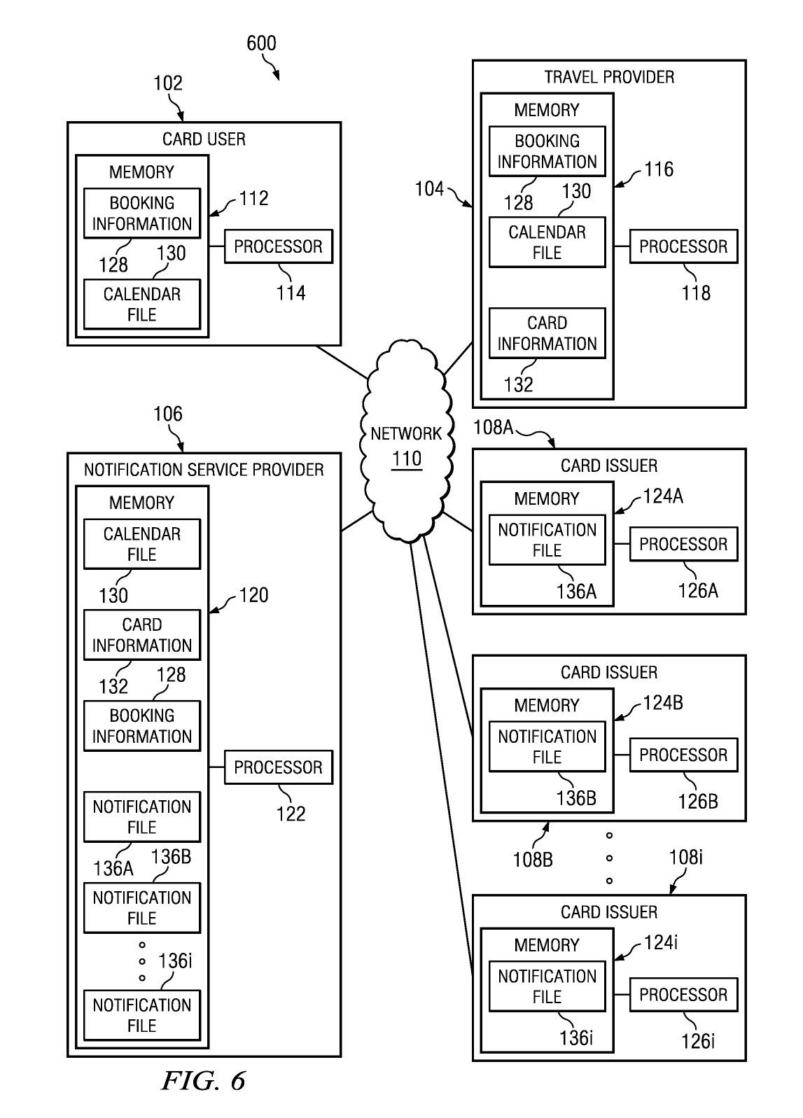

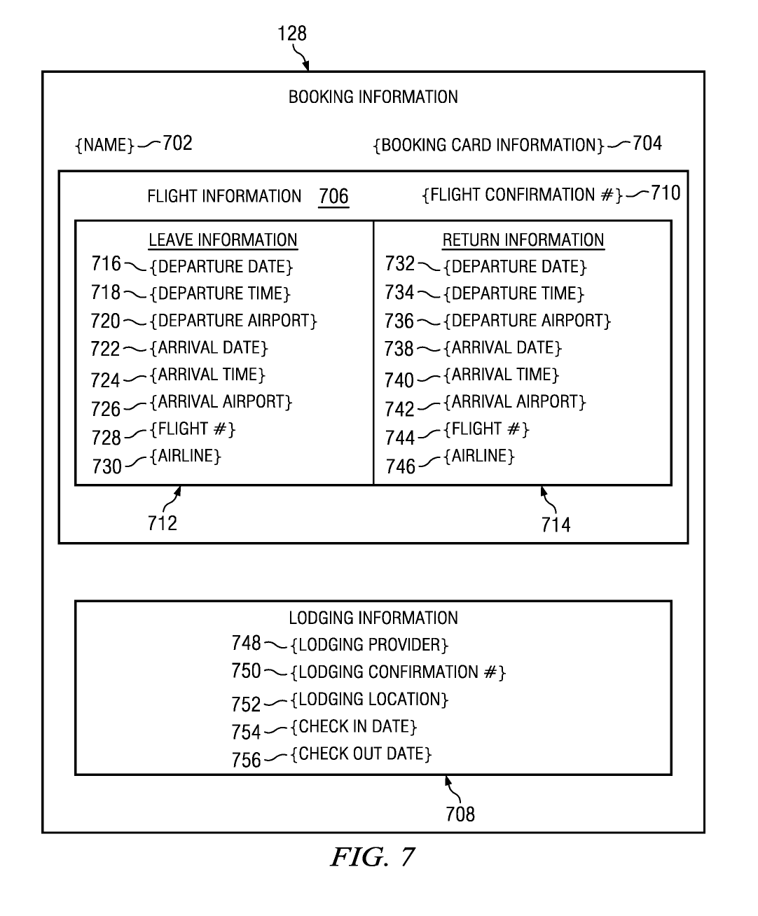

Based on the card user's desired travel, processor 118 of travel provider IHS 104 may book the user's travel (e.g., transportation and/or lodging, etc.). Upon booking the travel, processor 118 of travel provider IHS 104 may generate booking information 128 indicating the card user's travel (e.g., transportation and/or lodging) and may store booking information 128 in memory 116. Booking information 128 is described in further detail with respect to FIGS. 6 and 7.

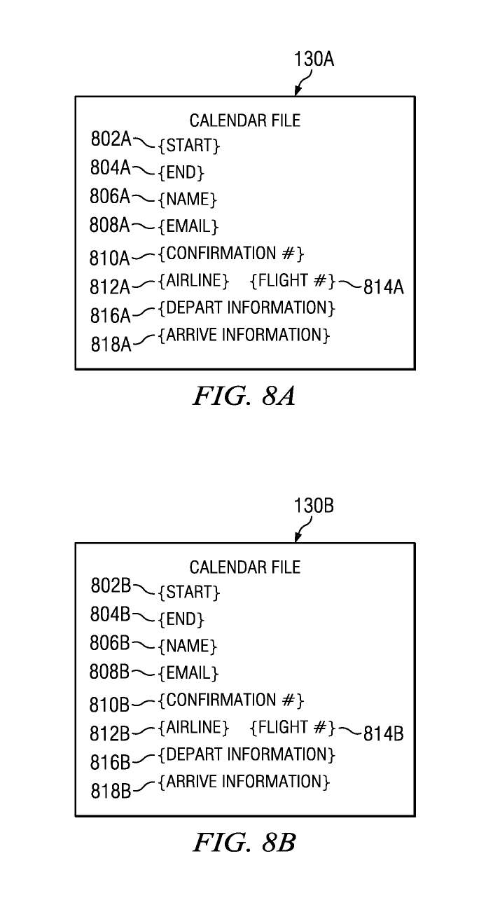

In some embodiments, processor 118 of travel provider IHS 104 may also generate a calendar file 130 associated with booking information 128. Processor 118 may also store calendar file 130 in memory 116. Calendar file 130 may include some or all of the information included in booking information 128. Calendar file 130 may comprise a file and file type that may be used by a calendar tool (e.g., Google calendar, Microsoft Outlook, etc) such that the calendar tool may populate the card user's travel into the card user's calendar. Calendar file 130 may comprise any suitable file type, including, but not limited to, a *.ics file type, a *.vcal file type or a *.vcs file type. In some embodiments travel provider IHS 104 may generate a calendar file 130 for one or more of the appropriate file types. Calendar file 130 is described in further detail with respect to FIGS. 6 and 8.

In some embodiments, upon booking the travel, the travel provider may request whether the user wants the travel provider to notify purchase card issuers of cards that may be used by the card user during the upcoming travel such that geographic restrictions on the use of the cards in the area of travel during the times of travel may be disabled. If the user indicates so, the travel provider may request card information 132 from the user. This information may be related to a card used to purchase the upcoming travel and/or may be related to one or more other cards. In the present embodiment, travel provider IHS 104 may prompt the card user (or representative thereof) using card user IHS 102 to provide card information 132 via network 110. In alternative embodiments, a travel provider agent may request the information via telephone or in person and may enter the information in travel provider IHS 104. Processor 118 may be configured to store card information 132 in memory 116 of travel provider IHS 104.

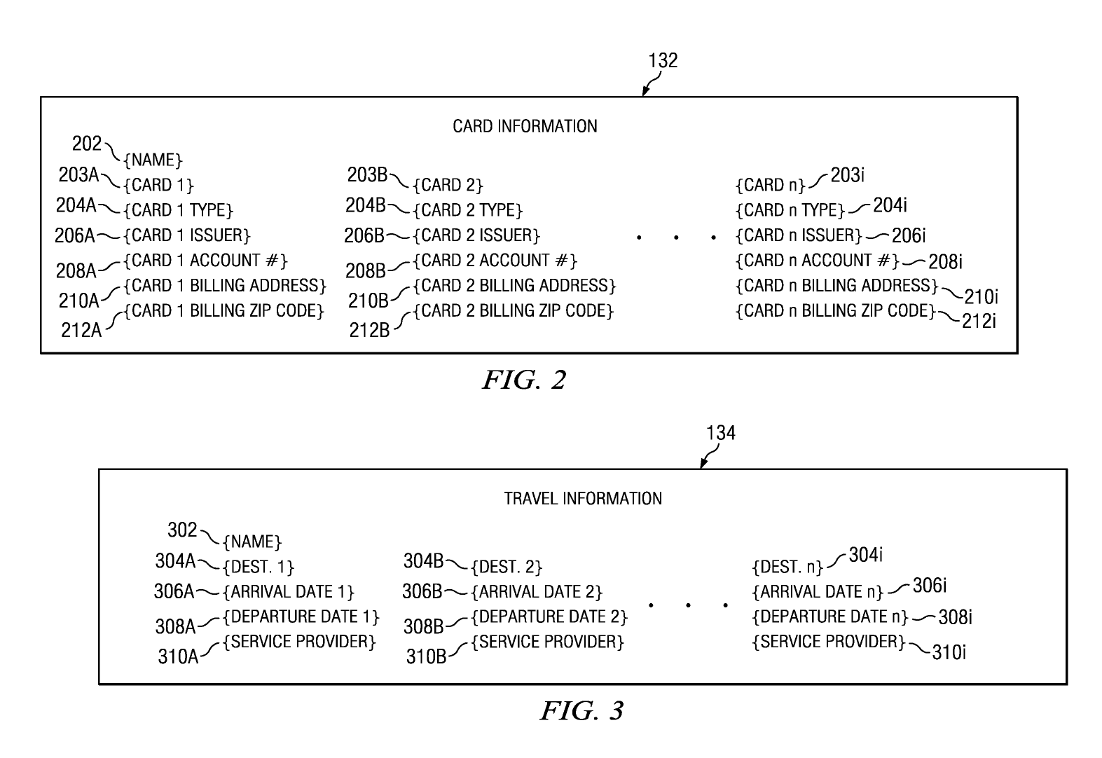

FIG. 2 illustrates an example of card information 132 in accordance with some embodiments of the present disclosure. As shown in the present example, card information 132 may include information associated with one or more cards that a card user may want available for use while traveling. In the present example, card information 132 may include name information 202 that may indicate the name of the card user or the account holder associated with the cards. Card information 132 may also include, but is not limited to, a card indicator 203 that indicates entries of card information for a card. For example, card indicator 203A may indicate that card information 132 may include information for a first card (e.g., “Card 1”), card indicator 203B may indicate information for a second card (e.g., “Card 2”) and so on until an nth card indicated by card indicator 203i (e.g., “Card n”).

Card information 132 may also include a card type entry 204 for each card (e.g., card type entry 204A for “Card 1,” card type entry 204B for “Card 2,” etc.). Card type entry 204 may indicate the credit card company associated with each card (e.g., Visa, Master Card, American Express, etc.) and/or whether the card is debit and/or credit card. Card information 132 may also include card issuer information 206 for each card (e.g., issuer information 206A for “Card 1,” issuer information 206B for “Card 2,” etc.). Issuer information 206 may indicate information associated with the issuer such as, for example, the bank, credit union or any other financial institution that issued the card.

Further, card information 132 may include information other than the name of the card user that may identify the account associated with the card user. For example, card information 132 may include card number information 208 for each card (e.g., card number information 208A for “Card 1,” card number information 208B for “Card 2,” etc.). In some embodiments, card number information 208 may include the entire card number, an encrypted version of the card number, or a portion of the card number (e.g., the last four digits). In the same or alternative embodiments, card information 132 may include billing address information 210 for each card that includes the full billing address or card information 132 may include billing zip code information 212 that may indicate just the billing zip code. Account number information 208, billing address information 210, and billing zip code information 212 are merely examples of account identification information that may be used to link a card user with a particular account.

Modifications, additions or omissions may be made to card information 132 without departing from the scope of the present disclosure. For example, any suitable information that may be used to identify the accounts and card issuers of cards used by the card user may be included in card information 132. Further, in some embodiments, card information 132 may be associated with one or more cards even though card information 132 is depicted as being associated with more than one card.

Returning to FIG. 1, processor 118 may also be configured to generate travel information 134. Travel information 134 may include data that may be used by a card issuer for allowing use of the card in an area of travel located outside of the typically allowed geographic area for use of the card. In some embodiments, processor 118 may directly generate travel information 134 upon the travel provider booking the card user's travel based on the travel requests of a card user.

FIG. 3 illustrates an example of travel information 134, in accordance with some embodiments of the present disclosure. As shown in the present example, travel information 134 may include information associated with the travel destinations and dates of a card user. For example, travel information 134 may include name information 302 that indicates the name of the person traveling (e.g., the traveling card user). Travel information 134 may also include destination information 304 that may indicate each destination of the card user, based on the booked travel. For example, a card user may travel to a first destination indicated by “Dest. 1” of destination information 304A, a second destination indicated by “Dest. 2” of destination information 304B until an nth destination indicated by “Dest. n” of destination information 304i. The destinations may be destinations of extended stay or may also be travel layover or stopover locations. The destinations may be derived from airport locations, booked lodging locations, bus station locations, train station locations, car rental locations, etc.

Travel information 134 may additionally include arrival and departure date information for each destination such that the card issuers may be notified of the appropriate date ranges to allow purchases within each destination and its surrounding areas. The arrival and departure information may be based on transportation arrival and departure dates to and from the particular destination (e.g., flight arrival and departure dates, train arrival and departure dates, boat arrival and departure dates, bus arrival and departure dates, etc.), car rental dates, and/or check in and checkout dates in lodging and derived from the booked travel.

For example, travel information 134 may include arrival date information 306A populated with “Arrival Date 1” indicating the date that the card user may arrive at “Dest. 1” of destination information 304A. Travel information 134 may also include departure date information 308A populated with “Departure Date 1” indicating the date that the card user may leave “Dest. 1” of destination information 304A. Travel information 134 may similarly include arrival date information 306B-306i and departure date information 308B-308i respectively associated with destination information 304B-304i.

Travel information 134 may further include travel service provider information 310 for each destination indicated by destination information 304. Travel service provider information 310 may include any information that may indicate the travel service provider that is to provide travel services for the card user during the time of travel. For example, in instances where the card user is flying, travel service provider information 310 may indicate an airline, flight number, and/or confirmation or record code associated with the card user's flights to and from the destination. In the same or alternative embodiments, travel service provider information 310 may also include lodging confirmation codes, the names of places of booked lodging (e.g., hotel name), car rental confirmations, booked car rental agencies, etc. A confirmation code may refer to any series of characters (e.g., numbers, letters, special characters, etc.) that may be used by a travel provider as a record locator for the booked travel.

Modifications, additions or omissions may be made to travel information 134 without departing from the scope of the disclosure. Travel information 134 of FIG. 3 merely depicts an example of the information that may be stored to notify a card issuer of a card user's travel dates. Additionally, in the present embodiment, travel information 134 includes information associated with more than one destination, but in alternative embodiments, processor 118 may generate a separate travel information 134 file for each destination. Additionally, in some embodiments the information included in travel information 134 and card information 132 may be combined into a single file. Further, in other embodiments, the information in travel information 134 may be included in multiple files.

Returning to FIG. 1, in some embodiments, processor 118 may direct travel provider IHS 104 to transmit travel information 134 and card information 132 to notification service provider IHS 106 via network 110. Travel information 134 and card information 132 may be stored together in a single file or separately. Processor 122 of notification provider IHS 106 may store travel information 134 and card information 132 on memory 120 of notification provider IHS 106. Processor 122 may use card information 132 and travel information 134 to generate one or more notification files 136 used to notify one or more card issuers of the card user's travel.

For example, as described with respect to FIG. 2, in some embodiments, card information 132 may include information associated with a purchase card “Card 1,” another purchase card “Card 2,” etc. up to a purchase card “Card n.” Accordingly, using card information 132, processor 122 may generate a notification file 136A for “Card 1,” a notification file 136B for “Card 2,” etc. up to a notification file 136i for “Card n.”

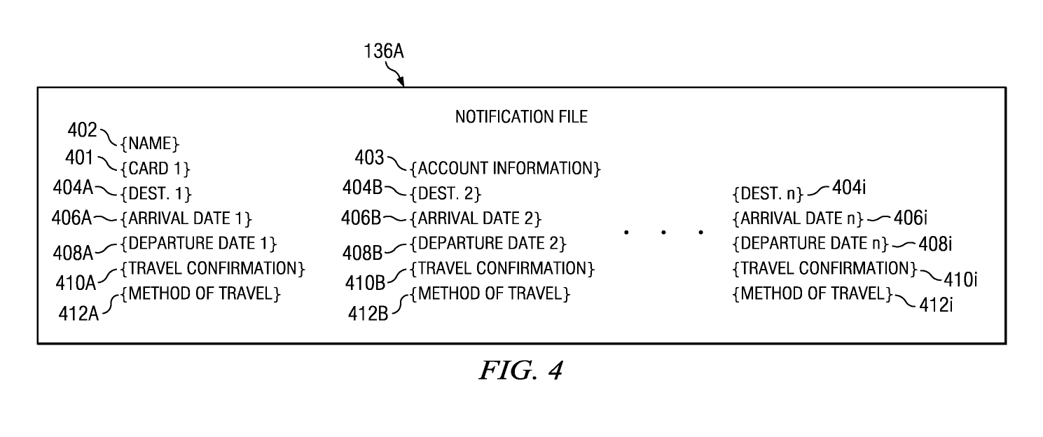

FIG. 4 illustrates an example of notification file 136A associated with “Card 1” indicated by card indicator 203A of card information 132. Notification file 136A may include name information 402 that indicates the card user's name.

Processor 122 may populate name information 402 based on name information 202 of card information 132 and/or name information 302 of traveler information 134. For example, in some embodiments, processor 122 may use both name information 202 and name information 302 to cross reference the name of the traveling card user such that the appropriate name is included in notification file 136A.

Notification file 136A may also include card indicator information 401 substantially similar to card indicator information 203A of card information 132. Accordingly, processor 122 may populate card indicator information 401 with “Card 1” to indicate that notification file 136A is associated with “Card 1.” Notification file 136A may additionally include account information 403 associated with “Card 1” and derived from card information 132. For example, account information 403 may include the card number of “Card 1” derived from card number information 208A of card information 132. In the same or alternative embodiments, account information 430 may include billing address information derived from billing address information 210A of card information 132 and/or any other type of information that may be used to identify and link the card user indicated in name information 402 with “Card 1” indicated by card indicator 401.

Notification file 136A may further include destination information 404 for each destination of the card user, and arrival information 406 and departure information 408 associated with each destination. Processor 122 may derive destination information 404, arrival information 406 and departure information 408 from travel information 134.

For example, notification file 136A may include destination information 404A populated with “Dest. 1” derived from destination information 304A of travel information 134 and indicating that the card user may be visiting “Dest 1.” Notification file 136A may also include arrival information 406A populated with “Arrival Date 1” which may indicate the card user's arrival date to “Dest. 1,” as derived from arrival information 306A of travel information 134. Notification file 136A may include departure information 408A populated with “Departure Date 1” which may indicate the card user's departure date from “Dest. 1,” as derived from departure information 308A of travel information 134. Notification file 136A may similarly include destination information 404B-404i, arrival date information 406B-406i and departure date information 408B-408i associated with destinations “Dest. 2” through “Dest. n” indicated by travel information 134.

Further, notification file 136A may include method of travel information 412A-412i associated with destinations “Dest 1” through “Dest. n” respectively. Method of travel information 412 may indicate the method of travel used to arrive at the particular destination (e.g., plane, bus, train, ship, etc.). Additionally, method of travel information 412 may also include information that may indicate a method of transportation of the card user once the card user arrives at the destination. Accordingly, method of travel information 412 may indicate the amount of travel that may be done by the card user once arriving at a destination such that the authorized area surrounding the destination for use of the card may be adjusted.

For example, method of travel information 412A may indicate that the card user is to arrive at “Dest. 1” via airplane and may also indicate that the card user is going to rent a car at “Dest. 1” for a method of transportation in “Dest. 1.” The rental car indicates that the card user may travel in a larger area surrounding “Dest. 1” than if the card user did not rent a car. Therefore, when authorizing use of the card at “Dest. 1” (as described further below), the card issuer may increase the size of the area surrounding “Dest. 1” where the card may be used based on the card user renting a car as indicated by method of travel information 412A.

Notification file 136A may further include travel confirmation information 410 associated with each destination that may indicate whether travel by the card user to the destination actually occurred. In some embodiments, processor 122 may determine whether travel has occurred by using information included in travel service provider information 310 of travel information 134. For example, as indicated in destination information 304A of travel information 134, the card user may be scheduled to travel to “Dest 1.” Processor 122 may be configured to derive the airline, flight number and/or confirmation code from travel service provider information 310A of travel information 134 and associated with “Dest. 1.” Processor 122 may be configured to use the travel service provider information 310A to check the flight status of the flight, determine whether the card user checked in to board the flight, determine whether the card user's boarding pass was scanned indicating that the card user actually boarded the flight, determine whether the card user cancelled travel on the flight etc., or any other indicator that may indicate whether travel by the card user occurred or likely occurred. In the same or alternative embodiments, processor 122 may also be configured to verify whether the card user checked in to a hotel indicated by travel service provider information 310A.

In the same or alternative embodiments, travel information 134 may include mobile phone information (not expressly shown in FIG. 3) associated with the mobile phone of the card user. The mobile phone information may include information that may be used to determine the location of the mobile phone (e.g., gps information access) of the card user and, thus, determine the likely location of the card user. Processor 122 may be configured to determine the location of the card user's mobile phone to help verify whether the indicated travel to “Dest. 1” occurred or likely occurred. Processor 122 may perform similar operations with respect to other destinations indicated by travel information 134 (e.g. “Dest. 2” through “Dest. n”).

Upon determining whether or not travel has likely occurred, processor 122 may populate the travel confirmation information 410 associated with a destination (e.g., travel confirmation information 410A associated with “Dest. 1) with an indicator indicating that travel to the destination likely occurred (e.g., “Travel Confirmed”), an indicator indicating that travel to the destination likely did not occur (e.g., “Travel not Confirmed”) or any other suitable indicator. In some embodiments, based on the gathered confirmation information, processor 122 may also indicate in travel confirmation information 410 a degree of likelihood that the travel occurred.

Modifications, additions or omissions may be made to notification file 136A without departing from the scope of the present disclosure. For example, in the present embodiment, notification file 136A includes information with respect to more than one destination, however, in alternative embodiments, a separate notification file 136 may be generated for each separate destination, or for a subset of destinations. Additionally, in the present example, notification file 136A is associated with a single purchase card, however in some instances notification file 136A may include information associated with more than one card. For example, a card user may use more than one card issued by the same card issuer, such that notification file 136A may include information associated with all of the cards associated with the card issuer.

Returning to FIG. 1, upon creating notification files 136, processor 122 may direct notification service provider IHS 106 to transmit, via network 110, each notification file 136 to the card issuer IHS 108 associated with the cards indicated in each respective notification file 136. Processor 122 may determine the appropriate card issuer based on information included in card information 132, such as card issuer information 206.

For example, as discussed above, notification file 136A may be associated with “Card 1” indicated in card information 132. Accordingly, processor 122 may determine from card issuer information 206A of card information 132 that the issuer of “Card 1” is “Card 1 Issuer.” Further, card issuer IHS 108A may be associated with “Card 1 Issuer.” Accordingly, processor 122 may direct notification service provider IHS 106 to communicate notification file 136A to IHS 108A, via network 110, based on the information included in card information 132. Processor 122 may similarly determine that notification files 136B-136i associated with “Card 2” through “Card n” may be associated with card issuer IHS's 108B-108i respectively. Processor 122 may accordingly direct notification service provider IHS 106 to communicated to card issuer IHS's 108B-108i notification files 136B-136i respectively.

Card issuer IHS's 108 may each include a processor 126 configured to store the received notification files 136 in a memory 124 of the card issuer IHS 108. Processors 126 may be configured to modify the accounts of the cards as indicated in notification files 136 to authorize use of the cards in the indicated destinations and surrounding areas for the travel dates also indicated by notification files 136. In some embodiments, a processor 126 may be configured to update an account such that a card may be used in an indicated destination for an indicated time period based on whether or not travel has likely occurred as indicated by travel confirmation information 410. In other embodiments, notification file 136 may not include travel confirmation information 410 and processor 126 may authorize the use of the indicated card based on the assumption that the travel will occur.

In some embodiments, processor 122 may direct notification service provider IHS 106 to communicate a notification file 136 to a card issuer IHS 108 before the dates of travel such that travel confirmation or verification may occur at a later time when travel is scheduled to occur. In such instances, upon verifying whether travel has likely occurred or not, processor 122 may communicate information to the appropriate card issuer IHS 108 such that travel confirmation information 410 stored in memory 124 of the card issuer IHS 108 may be updated. Therefore, the card issuer may authorize the use of the card in a particular area for a particular period of time indicated by the notification file 136 upon confirmation information 410 now indicating that travel to that area has likely occurred. If confirmation information 410 is updated such to indicate that travel likely did not occur, the card issuer may not authorize the use of the card in the destinations indicated by the notification file 136.

In alternative embodiments, processor 122 may not transmit a notification file 136 to a card issuer IHS 108 until after travel has been verified or confirmed. Therefore, when travel is determined to have likely occurred, the card issuer IHS 108 may receive the notification file 136 and may authorize use of the card in the destinations for the period of time indicated by the notification file 136. Additionally, in instances where travel is determined to not likely have occurred, notification service provider IHS 106 may not communicate the notification file 136 to the card issuer IHS 108. Therefore, the card issuer IHS 108 may not even know that travel was planned and, thus, may not authorize use of the card in areas outside of the typically allowed geographic limits of card use.

Therefore, travel provider IHS 104, notification service provider IHS 106 and issuer IHS's 108 may be configured such that a purchase card may be authorized to be used in an area of travel outside of the normally authorized use area without requiring the card user to personally notify the card issuer. Such a configuration may reduce or eliminate the time and inconvenience associated with traditional methods of doing so.

Modifications, additions or omissions may be made to system 100 without departing from the scope of the present disclosure. For example, in the present embodiment, notification service provider IHS 106 is described as generating notification files 136. However, in alternative embodiments a travel provider IHS 104 may generate a notification file 136 and may transmit notification file 136 to notification service provider IHS 106. In other embodiments, a travel provider IHS 104 may generate notification file 136 and may communicate notification file 136 to a card issuer IHS 108 such that a notification service provider 106 may not be required. In yet additional embodiments, notification service provider 106 may receive card information 132 from a card user who may have an account with the notification service provider instead of from a travel provider. In other embodiments, card user IHS 102 may be configured to generate card information 132, travel information 134 and/or notification file 136 upon the card user booking travel and card user IHS 102 may communicate notification file 136 to notification service provider IHS 106, which may forward notification file 136 to a card issuer IHS 108. Further, although a specific number of information handling systems, files, destinations, card issuers, cards, etc., are depicted it is understood that these are for illustrative purposes and the present disclosure is not limited to such.

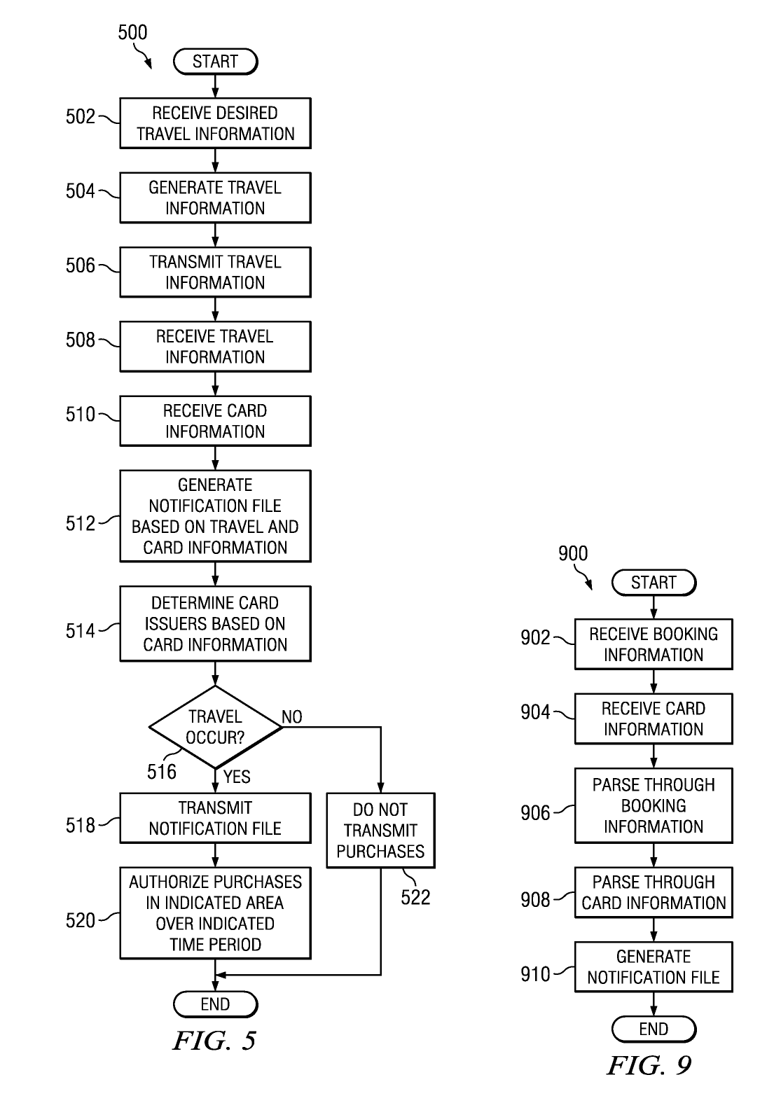

FIG. 5 illustrates an example method 500 for notifying a card issuer of travel of a card user. Method 500 may be performed by any suitable, system, apparatus or device configured to perform one or more of the steps of method 500. In the present example method 500 may be performed by one or more information handling systems (e.g., card user IHS 102, travel provider IHS 104, notification service provider IHS 106 and/or card issuer IHS 108 of FIG. 1); however any suitable components other than those specifically listed may perform the operations described herein.

Method 500 may start, and at step 502 a travel provider may receive desired travel information (e.g., desired destination, mode of transportation, duration of travel, desired lodging, etc.) from a card user or a representative of the card user. The desired travel information may be received at a travel provider IHS and may be received from the card user via a network (e.g., network 110 of FIG. 1). In other embodiments, an agent of the travel provider may receive the information from the card user (e.g., over the phone or in person) and may enter the information in the travel provider IHS such that the travel provider IHS receives the booking information.

At step 504, the travel provider IHS may generate travel information based on the travel booking information. The travel information may be substantially similar to travel information 134 described above in FIGS. 1 and 3. At step 506, the travel provider IHS may communicate the travel information to a notification service provider IHS via the network. In alternative embodiments, the travel provider IHS may communicate the travel information to a card user IHS via the network and the card user IHS may transmit the travel information to the notification service provider. At step 508, the notification service provider IHS may receive the travel information.

At step 510, the notification service provider IHS may receive card information that may be substantially similar to card information 132 described above in FIGS. 1 and 2. In some embodiments, the travel provider IHS may receive the card information and may transmit the card information to the notification service provider IHS. In alternative embodiments, the notification service provider IHS may receive the card information from a card user IHS.

At step 512 the notification service provider IHS may generate a notification file based on the travel and card information. The notification file may be substantially similar to notification file 136 described above with respect to FIGS. 1 and 4. At step 514, the notification service provider IHS may determine which card issuers are associated with which notification files based on information found in the card information received and based on the cards indicated in the notification file.

At step 516, the notification service provider IHS may verify whether or not travel by the card user likely occurred, as described above with respect to FIG. 1. If the notification service provider IHS determines that travel likely did occur, method 500 may move to step 518, otherwise method 500 may move to step 522.

At step 518, upon determining that travel likely did occur, the notification service provider IHS may transmit the notification file to the appropriate card issuer IHS via the network. As described above, in other embodiments, the notification service provider IHS may communicate the notification file before verifying travel and may communicate to the card issuer IHS whether travel likely occurred at a later time, such that the notification file may be updated at the later time by the card issuer IHS.

At step 520, the card issuer IHS may authorize use of the card or cards indicated in the notification file for the destination or destinations indicated in the notification file during the dates indicated in the notification file. In the present example, the card issuer IHS may authorize use of the card based on the notification file indicating that travel likely occurred. Following step 520, method 500 may end.

At step 522 if the notification file indicates that travel likely did not occur, the notification service provider IHS may not transmit the notification file to the card issuer IHS, such that purchases in the area of cancelled travel may not be authorized. In alternative embodiments, the notification service provider IHS may transmit the notification file to the card issuer IHS prior to the dates of travel and may communicate to the card issuer IHS an update to the notification file to indicate that travel has not occurred. In such instances the card issuer IHS may not authorize use of the card in the indicated travel area due to travel not being verified. Following step 522, method 500 may end. Therefore, method 500 may be used to generate a notification file indicating travel of a card user and may be used to transmit the notification file to a card issuer IHS. Accordingly, the card issuer IHS may authorize use of the purchase card in the area of travel during period of travel as indicated by the notification file.

Modifications, additions or omissions may be made to method 500 without departing from the scope of the present disclosure. For example, as mentioned above, in some embodiments, method 500 may not include travel verification step 516 and the card issuer IHS may authorize use of the card at the indicated locations during the indicated dates based on the assumption that travel has occurred or will occur. Further the order of the steps performed in method 500 may be different than those depicted. For example, steps 508 and 510 may be performed in a different order or in some instances may be performed at the same time.

FIG. 6 illustrates an example embodiment of a system 600 configured to notify a purchase card (e.g., debit card and/or credit card) issuer of a card user's travel plans based on booking information. Similarly to system 100, system 600 may include a card user IHS 102, a travel provider IHS 104, a notification service provider IHS 106 and card issuer IHS's 108 described above. Additionally, as described above, travel provider IHS 104 may receive desired travel information from a card user, may book the travel according to the desired travel information and may generate booking information 128 and/or a calendar file 130 based on the booked travel. As described in further detail below, and mentioned briefly above, in the present example, notification service provider IHS 106 may receive booking information 128 and/or a calendar file 130 and may be configured to generate a notification file 136 according to card information 132 and booking information 128 and/or a calendar file 130. In contrast, in FIG. 1 travel provider IHS 104 may generate travel information 134 and notification service provider IHS 106 may generate a notification file based on travel information 134.

FIG. 7 illustrates an example of booking information 128 that may be generated by travel provider IHS 104 according to some embodiments of the present disclosure. In the present example of FIG. 7, the card user may travel via an airplane, such that booking information 128 may include flight information 708. However, in other embodiments, booking information 128 may include information related to other modes of transportation (e.g., train, bus, boat). Additionally, in the present example, booking information 128 may include lodging information 708 indicating the lodging arrangements of the card user while traveling. In other embodiments, booking information 128 may include only transportation information or only lodging information.

Booking information may include name information 702 that may indicate the name of the traveling card user. Booking information 128 may also include booking card information 704 that may indicate information about a card used to book the travel arrangements. Booking card information 704 may include information such as the payment company associated with the card (e.g., Visa, Master Card, American Express, etc.), all or a portion of the card number (in some instances encrypted) etc.

As mentioned above, booking information 128 may further include flight information 706 that may include flight confirmation code information 710. Flight confirmation code information 710 may include any series of characters (e.g., numbers, letters, special characters etc.) that may be used to locate the records of the card user's booked flight.

Flight information 708 may also include leave information 712 associated with the card user leaving for the desired travel destination. For example, leave information 712 may include departure date information 716 and departure time information 718 indicating the date and time, respectively, that the card user may leave for the desired destination. Leave information 712 may also include departure airport information 720 that may indicate the airport from which the card user is leaving to begin travel. In some embodiments, Departure airport information 720 may include the airport code of the departure airport.

Leave information 712 may further include information related to the card user's arrival at the traveled to destination. For example, leave information 712 may include arrival time information 724 and arrival date information 722 respectively indicating the time and date that the card user may arrive at the desired destination. Leave information 712 may also include arrival airport information 726 which may indicate the airport at which the card user may be arriving. Arrival airport information 726 may thus include the airport code of the destination airport in some embodiments. Leave information 712 may also include flight code information 728 and airline information 730 that may respectively indicate the flight and airline associated with the card user's travel to the desired destination.

Travel information 706 may also include return information 714 associated with the card user returning from the travel destination. For example, return information 714 may include departure date information 732 and departure time information 734 respectively indicating the date and time of the card user's departure from a travel destination to return home. Return information 714 may also include departure airport information 736 that may indicate the airport from which the card user is departing from the destination (e.g., the traveled to destination airport code).

Return information 714 may also include arrival date information 738 and arrival time information 740 respectively indicating the date and time that the return flight may arrive at the card user's home area. Return information 714 may further include arrival airport information 742 indicating the airport of arrival of the return flight. Return information 714 may further include other information such as return flight code information 744 and return airline information 746 that may respectively indicate the flight and airline associated with the card user's departure from the traveled to destination.

Further, as mentioned above, booking information 128 may include lodging information 708 indicating lodging arrangements made by the card user for the desired travel. For example, lodging information 708 may include lodging provider information 748 that may indicate the provider of the lodging (e.g., hotel name). Lodging information 708 may further include lodging confirmation information 750 that may indicate a confirmation code associated with the card user's booked lodging. Lodging information 708 may additionally include lodging location information 752 that may indicate the location (e.g., address) of the lodging. Further, lodging information 708 may include check in date information 754 indicating the check in date of the card user to the lodging and check out date information 756 indicating the date the card user is scheduled to check out of the lodging.

Modifications, additions or omissions may be made to booking information 128 without departing from the present disclosure. FIG. 7 merely illustrates an example of booking information 128 and other embodiments may include more or less information than that depicted. For example, booking information 128 may include flight information associated with flights taken during travel and/or layovers and thus may include information with respect to one or more destinations. Additionally, booking information 128 may be split up such that a booking information file is associated with leave information 712, another booking information file is associated with return information 714 and yet another booking information file is associated with lodging information 708, or any combination thereof. Also, although flight information is specifically depicted in FIG. 7, it is understood that booking information 128 may include information associated with any other mode of transportation that may be used by the card user.

FIGS. 8A and 8B illustrate example calendar files 130A and 130B that may be generated by travel provider IHS 104 according to some embodiments of the present disclosure. Calendar files 130 may comprise information included in booking information 128, but generated in a different format. For example, booking information 128 may be in the format of an email and calendar files 130 may be in a calendar file format such as, for example, an *.ics format, a *.vcs format, and/or a *.vcal format. Calendar files 130 may be used to incorporate an event (e.g., flight, hotel stay, etc.) associated with the card user's travel.

In the present example, calendar file 130A may include event entries associated with a card user's travel to a destination via an airplane and calendar file 130B may include event entries associated with a card user's return travel home from the destination via an airplane. Calendar files 130 may include start information 802 that may indicate the starting time and date of an event. In the present example of calendar file 130A, the event may be the card user's flight to the desired travel destination and start information 802A may indicate the departure time and date of the card user's flight to the desired destination. Calendar file 130A may also include end information 802A that may indicate the ending time and date of an event. In the present embodiment, end information 802A may indicate the arrival time and date of the card user's flight to the desired destination. Calendar file 130B may include similar start information 802B and end information 804B associated with the card user's return flight home from the destination.

Calendar files 130 may also include name information 806 and email information 808 indicating the name and email of the traveling card user. Calendar files 130 may also include confirmation code information 810 that may act as a record locator of the card user's flights to and from the desired destination. Calendar files 130 may further include airline information 812 and flight information 814 respectively indicating the airline and flight number, respectively, associated with the card user's flights to and from the desired destination.

Calendar file 130A may further include departure information 816A and arrival information 818A associated with the card user's flight to the desired destination. Departure information 816A may include information indicating the departure airport (e.g., departure airport code) and departure time and date. Arrival information 818A may include information indicating the arrival airport (e.g., arrival airport code) and arrival time and date. Calendar file 130B may similarly include depart information 816B associated with the departure of the card user's return flight from the traveled destination and arrive information 818B associated with the arrival of the card user's return flight.

Modifications, additions or omissions may be made to calendar files 130 without departing from the scope of the present disclosure. FIGS. 8A and 8B are merely an example of calendar files 130 and other calendar files 130 may include different information such as, for example, intermediate flights taken during travel to other traveled to destinations. Further, other calendar files 130 may indicate events such as, for example, a hotel stay and may include information similar to lodging information 708 of booking information 128 of FIG. 7. Additionally, although calendar files 130 have been described with respect to flights, it is understood that other calendar files 130 may indicate other modes of transportation or any other suitable travel information. Further, a calendar file 130 may include information associated with more than one event, for example, the information included in calendar files 130A and 130B may be included in a single calendar file 130.

Returning to FIG. 6, as mentioned above, following generation of calendar files 130 and/or booking information 128, travel provider IHS 104 may transmit booking information 128 and/or calendar file 130, via network 110 such that card user IHS 102 may access booking information 128 and/or calendar file 130. For example, in some embodiments, travel provider IHS 104 may transmit booking information 128 and/or calendar file 130 to an email account of a card user, and the card user may access the email account using card user IHS 102 and network 110. In some embodiments, card user IHS 102 may either temporarily or permanently store booking information 128 and/or calendar file 130 on memory 112. As mentioned above, in instances where calendar file 130 is received and accessed, card user IHS 102 may use calendar file 130 to populate a calendar of a calendar tool (e.g., Microsoft Outlook, Google calendar, etc.) with the card user's travel information.

In some embodiments, travel provider IHS 104 may communicate booking information 128 and/or calendar file 130 to notification service provider IHS 106 such that notification service provider IHS 106 may generate a notification file 136 at least partially based on booking information 128 and/or calendar file 130. In other embodiments, a card user may direct card user IHS 102 to communicate booking information 128 and/or calendar file 130 to notification service provider IHS 106.

Processor 122 of notification service provider IHS 106 may store calendar file 130 and/or booking information 128 in memory 120. As described with respect to FIGS. 1 and 2, memory 120 of notification service provider IHS 106 may also include card information 132 obtained from travel provider IHS 104 and/or card user IHS 102.

Notification service provider IHS 106 may generate notification files 136 for each card issuer of each card indicated in card information 132 based on card information 132 as described with respect to FIG. 1. Further, notification service provider IHS 106 may populate card information 401, and account information 403 of each notification file 136 based on card information 132 as described with respect to FIG. 1.

In some embodiments, booking information 128 may comprise an email and notification service provider IHS 106 may populate destination information 404, arrival date information 406 and departure date information 408 using booking information 128. For example, processor 122 of notification service provider IHS 106 may parse through leave information 712 of booking information 128 for arrival airport information 726 indicating an arrival airport (e.g., airport code) of the card user's leaving flight to determine a destination of the card user and may populate destination information 404 accordingly. In some embodiments, if booking information 128 includes a layover or stopover (not expressly shown), destination information 404A may be populated with the layover or stopover destination and destination information 404B may be populated with the final destination.

To determine the arrival date to the destination, processor 122 may parse through leave information 712 to determine the departure date of the card user's leaving flight based on departure date information 716 and/or may parse through leave information 712 to determine the arrival date of the card user's leaving flight based on arrival date information 722. Accordingly, processor 122 may populate arrival date information 406 of a notification file 136 based on flight departure date information 716 and/or flight arrival date information 722 of leave information 712 included in booking information 128.

To determine the departure date from the destination, processor 122 may parse through return information 714 to determine the departure date of the card user's returning flight based on departure date information 732 and/or may parse through return information 714 to determine the arrival date of the card user's returning flight based on arrival date information 738. Accordingly, processor 122 may populate departure date information 408 of a notification file 136 based on return flight departure date information 132 and/or return flight arrival date information 738 of return information 714 included in booking information 128.

Further, processor 122 may parse through booking information 128 to obtain flight confirmation codes from flight confirmation information 710. In the same or alternative embodiments, processor 122 may also parse through booking information 128 to obtain flight number information 728 and/or flight number information 744. Accordingly, processor 122 may use the obtained flight confirmation codes and/or flight numbers to determine whether travel likely occurred as described with respect to FIG. 1. Based on this determination, processor 122 may populate travel confirmation information 410 of a notification file 136.

As another example, to determine destination information 404, processor 122 of service provider IHS 106 may parse through lodging information 708 to derive the a destination based on lodging location information 752. Further, processor 122 may parse through lodging information 708 for check in date information 754 to determine a destination arrival date and may populate arrival date information 406 accordingly.

Processor 122 may also parse through lodging information 708 for check out date information 754 to determine a destination departure date and may populate destination date information 408 accordingly. Processor 122 may also parse through lodging information 708 to obtain a lodging confirmation code from lodging confirmation information 750 to determine whether travel likely occurred as described above with respect to FIG. 1. Based on this determination, processor 122 may populate travel confirmation information 410 of a notification file 136.

In other embodiments, processor 122 may parse through a calendar file 130 to populate at least one of destination information 404, arrival date information 406, departure date information 408 and travel confirmation information 410 of a notification file 136. For example, notification service provider IHS 106 may receive calendar file 130A of FIG. 8A associated with the card user's flight information to the desired destination and may also receive calendar file 130B of FIG. 8B associated with the card user's return flight information from the traveled to destination. Processor 122 may parse through calendar file 130A searching for information such as flight departure and arrival dates and airport codes to determine the originating location and destination of a flight indicated in calendar file 130A. Accordingly, processor 122 may determine that a card user is scheduled to board a flight to a particular destination on a particular date based on name information 806A, start information 802A, end information 804A depart information 816A and/or arrive information 818A.

Processor 122 may also parse through calendar file 130B for flight departure and arrival dates and airport codes to determine flight departure and arrival dates and airport codes to determine the originating location and destination of a flight indicated in calendar file 130B. Processor 122 may compare the arrival and departure dates derived from calendar files 130A and 130B and may determine that calendar file 130A may be associated with travel to the destination and that calendar file 130B may be associated with return travel from the destination. Processor 122 may make this determination based on the dates associated with calendar file 130A being earlier than the dates associated with calendar file 130B. Accordingly, processor 122 may determine that the arrival airport indicated by arrive information 818A (or the departure airport indicated by depart information 816B) may indicate the destination of travel and may populate destination information 404 of a notification file 136 accordingly.

Based on the departure and arrival dates of calendar file 130A respectively indicated by depart information 816A and arrive 818A, processor 122 may also determine the destination arrival date and may populate arrival date information 406 of a notification file 136 accordingly. Further, based on the departure and arrival dates of calendar file 130B respectively indicated by depart information 816B and arrive information 818B, processor 122 may determine the destination departure date and may populate depart date information 408 accordingly.

Further, processor 122 may parse through calendar file 130A to obtain confirmation codes from confirmation code information 810A. In the same or alternative embodiments, processor 122 may also parse through calendar file 130A to obtain flight number information 814A. Accordingly, processor 122 may use the obtained flight confirmation codes and/or flight numbers to determine whether travel likely occurred as described with respect to FIG. 1. Based on this determination, processor 122 may populate travel confirmation information 410 of a notification file 136.

Following the generation of a notification file 136 for each card issuer, notification service provider IHS 106 may transmit each notification file 136 to card issuer IHS's 108 as described above with respect to FIG. 1. Therefore, notification service provider IHS 106 may generate a notification file 136 indicating travel of a card user and may transmit the notification file 136 to a card issuer IHS 108. Accordingly, the card issuer IHS 108 may authorize use of the purchase card in the area of travel during the period of travel indicated by the notification file.

Modifications, additions or omissions may be made to system 600 without departing from the scope of the present disclosure. For example, although notification service provider IHS 106 is described as generating notification file 136, in some embodiments travel provider IHS 104 and/or card user IHS 102 may generate notification file 136. Further, although a specific number of components (e.g., files, information handling systems, etc.) are depicted, it is understood that any number of components may be used depending on the specific configuration of system 600.

FIG. 9 illustrates an example method 900 for generating a notification file based on travel booking information. Method 900 may be performed by any suitable, system, apparatus or device configured to perform one or more of the steps of method 900. In the present example method 900 may be performed by a notification service provider IHS (e.g., notification service provider IHS 106); however any other suitable component (e.g., card user IHS 102, travel provider IHS 104, etc.) other than those specifically listed may perform the operations described herein.

Method 900 may start, and at step 902, a notification service provider IHS may receive travel booking information, such as booking information 128 described with respect to FIGS. 1, 6 and 7. In some instances the travel booking information may also, or alternatively, be in the form of a calendar file such as calendar files 130 of FIGS. 1, 8 and 6. The notification service provider IHS may receive the travel booking information and/or calendar file from a card user IHS and/or a travel provider IHS. At step 904, the notification service provider IHS may receive card information (e.g., card information 132) from the card user IHS and/or the travel service provider IHS.

At step 906, the notification service provider IHS may parse through the booking information and/or the calendar file to derive a destination of travel and dates of travel of a card user, as described above with respect to FIGS. 6 through 8. At step 908, the notification service provider IHS may also parse through the card information to derive card information that may be used to notify a card issuers of a card of the card user's travel, as described above with respect to FIGS. 1 and 2.

At step 910, the notification service provider IHS may generate a notification file based on the information derived from the card information and the booking information and/or calendar file as described above with respect to FIGS. 1, 2 and 6-8. Following step 910, method 900 may end. Therefore, method 900 may be used to generate a notification file indicating travel of a card user that may be transmitted to a card issuer IHS. The notification file may then be communicated to and used by card issuer IHS's 108 as described with respect to FIGS. 1 and 4. Accordingly, the card issuer IHS may authorize use of the purchase card in the area of travel during a period of travel as indicated by the notification file.

Modifications, additions or omissions may be made to method 900 without departing from the scope of the present disclosure. For example, although the steps of method 900 are described in a particular order, the order may be changed or some steps may be performed at approximately the same time. As an example, steps 902-908 may be done in different orders or at the same time. Additionally, parts of the notification file may be populated at different times, or all at once.

Although the present disclosure has been described with several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims.

What is claimed is:

1. A method for modifying a purchase card account according to travel by a user of a purchase card comprising:
receiving, at a card issuer information handling system associated with a card issuer of a purchase card, a computer readable travel notification file indicating a destination of travel of a card user of the purchase card, a time period of travel to the destination, account information associated with the purchase card and confirmation information indicating whether travel to the destination likely occurred; and
modifying, by the card issuer information handling system, an account associated with the purchase card based on the travel notification file to authorize use of the purchase card at the destination of travel during the time period of travel.

2. The method of claim 1, further comprising modifying the purchase card account to authorize use of the purchase card based on the confirmation information indicating that travel likely occurred.

3. The method of claim 1, wherein the confirmation information is based on verifying travel using a confirmation code associated with a travel service provider.

4. The method of claim 1, wherein the confirmation information is based on determining a location of a cell phone of the card user.

5. The method of claim 1, wherein the account information associated with the purchase card includes at least one of a name of the card user, a card number of the purchase card, a portion of the card number of the purchase card and a billing address associated with the purchase card.

6. The method of claim 1, wherein the destination indicated in the notification file is derived from at least one of an airport location, a lodging location, a train station location, a bus station location, a port location and a car rental location.

7. The method of claim 1, wherein the time period of travel indicated in the notification file is derived from at least one of a flight date, lodging check in and check out dates, a car rental date, a train passage date and a boat passage date.

8. The method of claim 1, wherein the destination and time period indicated by the notification file are derived by parsing through booking information associated with the travel of the card user.

9. The method of claim 8, wherein the booking information comprises a calendar file.

10. The method of claim 8, wherein the booking information is included in an email.

11. The method of claim 1, further comprising authorizing an area surrounding the destination for use of the purchase card based on a method of transportation at the destination indicated in the travel notification file.

12. An information handling system comprising:
a processor;
a computer readable memory communicatively coupled to the processor; and
processing instructions encoded in the computer readable memory, the processing instructions, when executed by the processor, configured to perform operations comprising:
receiving a computer readable travel notification file indicating a destination of travel of a card user of the purchase card, a time period of travel to the destination, account information associated with the purchase card and confirmation information indicating whether travel to the destination likely occurred; and
modifying an account associated with the purchase card based on the travel notification file to authorize use of the purchase card at the destination of travel during the time period of travel.

13. The information handling system of claim 12, wherein the processing instructions are further configured to perform operations comprising modifying the purchase card account to authorize use of the purchase card based on the confirmation information indicating that travel likely occurred.

14. The information handling system of claim 12, wherein the confirmation information is based on verifying travel using a confirmation code associated with a travel service provider.

15. The information handling system of claim 12, wherein the confirmation information is based on determining a location of a cell phone of the card user.

16. The information handling system of claim 12, wherein the account information associated with the purchase card includes at least one of a name of the card user, a card number of the purchase card, a portion of the card number of the purchase card and a billing address associated with the purchase card.

17. The information handling system of claim 12, wherein the destination indicated in the notification file is derived from at least one of an airport location, a lodging location, a train station location, a bus station location, a port location and a car rental location.

18. The information handling system of claim 12, wherein the time period of travel indicated in the notification file is derived from at least one of a flight date, lodging check in and check out dates, a car rental date, a train passage date and a boat passage date.

19. The information handling system of claim 12, wherein the destination and time period indicated by the notification file are derived by parsing through booking information associated with the travel of the card user.

20. The information handling system of claim 19, wherein the booking information comprises a calendar file.

21. The information handling system of claim 19, wherein the booking information is included in an email.

22. The information handling system of claim 12, wherein the processing instructions are further configured to perform operations comprising authorizing an area surrounding the destination for use of the purchase card based on a method of transportation at the destination indicated in the travel notification file.
